(19) United States
(12) Patent Application Publication
(10) Pub. No.: US 2020/0284158 A1
(43) Pub. Date: Sep. 10, 2020

(54) DEVICE FOR CLEANING TURBINE BLADES OF A JET ENGINE

(71) Applicant: Lufthansa Technik AG, Hamburg (DE)

(72) Inventors: Jan Sassmannshausen, Hamburg (DE); Eugen Roppelt, Hamburg (DE); Manuel Hagge, Bremen (DE)

(21) Appl. No.: 16/753,345

(22) PCT Filed: Oct. 16, 2018
(86) PCT No.: PCT/EP2018/078204

§ 371 Date: Apr. 3, 2020

(30) Foreign Application Priority Data
Oct. 16, 2017 (DE) 10 2017 218 425.6

(51) Int. Cl. F01D 25/00; B08B 3/02; B08B 7/00; B08B 9/00

(52) U.S. Cl. CPC F01D 25/002; B08B 3/026; F05D 2230/72; B08B 9/00; F05D 2220/323; B08B 7/00

(57) ABSTRACT

A device cleans turbine blades of a turbine stage of a jet engine. The device includes a cleaning lance. The cleaning lance is configured to be introduced into the jet engine through a through-opening. The cleaning lance has an outlet opening at one end thereof and a supply connection for supplying cleaning media at an other end thereof. The cleaning lance includes a guide configured to guide the cleaning lance for clear and reproducible positioning and orientation of the cleaning lance; and a securing device configured to releasably secure the guide to an outer side of the jet engine. The securing device is configured to adjustably orient the guide to a predetermined orientation with respect to the outer side of the jet engine.

### CROSS-REFERENCE TO PRIOR APPLICATIONS

This application is a U.S. National Phase Application under 35 U.S.C. § 371 of International Application No. PCT/EP2018/078204, filed on Oct. 16, 2018, and claims benefit to German Patent Application No. DE 10 2017 218 425.6, filed on Oct. 16, 2017. The International Application was published in German on Apr. 25, 2019 as WO 2019/076875 under PCT Article 21(2).

### FIELD

The invention relates to a device for cleaning turbine blades of a turbine stage of a jet engine.

### BACKGROUND

Aircraft jet engines have one or more compressor stages, a combustion chamber, and one or more turbine stages. In the turbine stages, the hot combustion gases, which originate from the combustion chamber, discharge a portion of their thermal and mechanical energy, which is used to drive the compressor stages. A contamination of an aircraft jet engine may lead to a reduction of the degree of efficiency, which results in increased fuel consumption and consequently increased environmental pollution. This applies particularly when the contamination forms a coating on the components of a jet engine through which air flows and thereby impairs the surface quality.

Particularly in aircraft that are used in desert regions, there is further the problem that the desert sand (CMAS) which is in the air is drawn in by the engine and, as a result of the high temperatures in the combustion chamber, becomes molten. When striking the high-pressure turbine blades (HPT blades), which are arranged in the flow direction downstream of the combustion chamber, the molten sand solidifies again. In addition, extremely fine sand reaches the cooling air, which is drawn off in the high-pressure compressor from the inner side into the internal cooling channels of the high-pressure turbine blades, which open at the profile projection of the blades in order to form a film cooling, and is deposited at that location. Both effects leads to a narrowing or blockage of the cooling air channels of the high-pressure turbine blades so that they are no longer sufficiently cooled. In connection with erosion effects and oxidation effects, the high-pressure turbine blades become worn substantially more quickly and the period of use and service-life is drastically reduced, in particular in comparison with use outside desert regions.

In order to clean the high-pressure turbine blades, the affected engine is removed from the aircraft and engine maintenance is undertaken in order, in this instance, to subject the high-pressure turbine blades to a repair cycle, which involves cleaning. This engine maintenance is complex and cost-intensive.

DE 10 2012 002 275 A1 discloses a method in which the aircraft engine can remain on the aircraft in order to clean the high-pressure turbine blades. To this end, via a lateral opening of the engine a cleaning device, where applicable using an auxiliary introduction means, is introduced into the combustion chamber and has a jet nozzle for producing a pressure fluid jet, by means of which deposits on the high-pressure turbine blades are intended to be removed. After the introduction, the cleaning device is freely movable and only slightly limited by any auxiliary introduction means, which may be provided. The orientation of the cleaning device with respect to the high-pressure turbine blades can be verified by means of a borescope which is guided through the cleaning device. The results of such a method are, however, not always satisfactory.

### SUMMARY

An embodiment of the present invention provides a device that cleans turbine blades of a turbine stage of a jet engine. The device includes a cleaning lance. The cleaning lance is configured to be introduced into the jet engine through a through-opening. The cleaning lance has an outlet opening at one end thereof and a supply connection for supplying cleaning media at an other end thereof. The cleaning lance includes a guide configured to guide the cleaning lance for clear and reproducible positioning and orientation of the cleaning lance; and a securing device configured to releasably secure the guide to an outer side of the jet engine. The securing device is configured to adjustably orient the guide to a predetermined orientation with respect to the outer side of the jet engine.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows an embodiment of a device according to the invention;

FIGS. 2a-c are schematic illustrations of a use of the device from FIG. 1;

FIG. 3 is a switch valve for the device according to FIGS. 1 and 2; and

FIGS. 4 and 5 are sectioned illustrations of the switch valve according to FIG. 3 in different switching positions.

### DETAILED DESCRIPTION

An embodiment of the present invention provides a device for cleaning turbine blades of a turbine stage of a jet engine, which is improved compared with the prior art.

The invention relates to a device for cleaning turbine blades of a turbine stage of a jet engine. The device includes a cleaning lance for introducing into a jet engine having an outlet opening at one end thereof and a supply connection for supplying cleaning medium at the other end thereof. The device includes a guide for the cleaning lance for clear and reproducible positioning and orientation of the cleaning lance with respect to the guide, and a securing device for releasably securing the guide to the outer side of the jet engine. The securing device has an orientation unit, by means of which the guide can be adjusted to a predetermined orientation with respect to the outer side of the jet engine.

The turbine blades, which are intended to be cleaned, may in particular be the high-pressure turbine blades of a high-pressure turbine stage, for example, the first high-pressure turbine stage.

The invention has recognized that for a continuously satisfactory cleaning of the turbine blades the cleaning medium should strike the surface of each turbine blade which is intended to be cleaned at a predetermined angle and—if the cleaning jet does not directly cover the entire surface which is intended to be cleaned—it is ensured that the cleaning jet is guided over the entire surface which is intended to be cleaned. The position and orientation of the outlet opening of the cleaning lance required for a good cleaning effect with respect to the turbine blades which are intended to be cleaned may be defined as specifications in this instance.

In order to comply in a reproducible manner with the specifications with respect to the position and orientation of the outlet opening of the cleaning lance with respect to the turbine blades, which are intended to be cleaned, there is first provision according to the invention for the cleaning lance to be guided through a guide in a securing device for clear and reproducible positioning and orientation of the cleaning lance. So that a guide is suitable “for clear and reproducible positioning and orientation of the cleaning lance”, the cleaning lance and/or guide has/have means, via which the relative movement with respect to each other can be determined in defined positions of the cleaning lance in the guide and/or the number of degrees of freedom of the cleaning lance in the guide is limited. In both cases, the guiding is carried out without play to the greatest possible extent.

For example, there may be provided locking elements and/or securing screws by means of which the cleaning lance can be adjusted selectively in positions with respect to the guide determined by the locking elements and/or securing screws. The locking elements and/or securing screws may in this instance be arranged in the guide or the cleaning lance The respective other component then has, for example, corresponding indentations or recesses for engagement of the locking elements and/or securing screws.

In order to limit the number of degrees of freedom of the cleaning lance in the guide, there may be provided, for example, groove, rail or linear guides that limit the degrees of freedom of the relative contact of the cleaning lance with respect to the guide to the direction predetermined by the groove and/or rail. The movability of the cleaning lance in the guide can thus be limited, for example, to an individual linear movement without degrees of freedom of rotation existing.

It is preferable for the guide to be constructed to limit the movability of the cleaning lance with respect to the guide to one degree of freedom. The degree of freedom may in this instance represent a rotational movement, a linear movement, and/or any, also partial, combination thereof. It is preferable for the single degree of freedom to which the movement is limited to be a rectilinear translation degree of freedom. It is preferable for the single degree of freedom to be configured in such a manner that—in the mounted state of the device—as a result of movement along the single degree of freedom, the outlet end of the cleaning lance is moved in a direction radial relative to the axis of the rotor of the jet engine, preferably in a linear manner.

So that the specifications that exist for a good cleaning action are also actually complied with regard to the position and orientation of the cleaning lance with respect to the turbine blades, which are intended to be processed, in addition to the described guiding of the cleaning lance it is further necessary for the guide itself to be arranged in a predetermined position and orientation with respect to the turbine blades which are intended to be cleaned. The position of the guide is in this instance substantially predetermined by the through-opening for the cleaning lance in the jet engine.

However, the invention has recognized that directly securing the guide to the outer side of the jet engine in the region of the through-opening without further adjustment possibilities cannot safely ensure a position and orientation of the cleaning lance in accordance with the specifications.

In order to enable this, the device according to the invention includes a securing device with an orientation unit, by means of which the orientation of the guide can be adjusted. As a result of the orientation unit of the securing device, orientation errors can be prevented.

The securing device may have as securing means a threaded portion for engagement in a thread of the through-opening for the cleaning lance and/or screws for releasable securing to the outer side of the jet engine. In particular, the threaded portion may be a portion of a hollow screw with a conically formed head. The cleaning lance may be guided through the hollow screw which in turn can engage in an inner thread of the through-opening. As a result of the conically formed head, with a suitable formation of the corresponding counter-piece of the securing device, it is possible for the counter-piece to be fixed to the through-opening in a position suitable for the desired orientation of the guide and to be secured in this position.

The securing device has, between the securing means or a portion of the securing device, which is secured in a fixed manner with respect to the jet engine (for example, the securing means), and the portion of the securing device which comprises the guide a movable and/or deformable portion which enables the orientation of the guide. The orientation device may act directly on this portion, for example, by the position of the two components of the securing device being able to be changed with respect to each other via the orientation device.

The orientation unit preferably has one or more stop faces, which are configured to abut defined components of the jet engine and to which the portion of the securing device that includes the guide are connected. In this instance, at least a portion of the stop faces can preferably be adjusted, for example, displaced using adjustment screws or threaded spindles. It is also possible for the free end of an adjustment screw to directly form an adjustable stop face. As a result of the stop faces, the orientation of the guide with respect to the outer side of the jet engine is fixed. The adjustability of the stop faces makes the orientation of the guide adjustable.

In the device according to the invention for cleaning turbine blades of a turbine stage of a jet engine, the position and orientation of the outlet opening of the cleaning lance can be reliably adjusted to a specification as a result of the orientability of the guide provided according to the invention and the reproducible positioning of the cleaning lance with respect to the guide. The correct orientation of the guide necessary for this purpose can be achieved by orientation of the guide with respect to components of the engine, the position of which can be used as a reliable reference, for example, by stop faces abutting these components. Alternatively or additionally, it is possible for the correct orientation of the guide to be found by means of measurement, for example, by means of laser, or by means of auxiliary orientation members arranged on the guide, for example, circular levels.

It is preferable for the device to include a guide mechanism, by means of which the cleaning lance can be moved along the guide. In this instance, the guide mechanism is preferably configured in such a manner that it moves the outlet end of the cleaning lance in a direction radial relative to the axis of the rotor of the jet engine, preferably in a linear manner. The movement may, for example, be achieved by limiting the movability of the cleaning lance to a corresponding single degree of freedom. In this instance, it is self-evident that the desired movement at the outlet end of the cleaning lance will generally only occur when the guide is orientated in accordance with the respective specifications.

The guide mechanism may have a crank drive for introducing the movement along the guide. As a result of a corresponding crank drive, an oscillating movement of the outlet end of the cleaning lance, which is advantageous for uniform cleaning of the turbine blade, can be achieved. This applies in particular to a so-called stochastic cleaning in which the cleaning of all the turbine blades of a stage is carried out together. To this end, the turbine stage is continuously rotated with the turbine blades which are intended to be cleaned and the jet of the cleaning medium discharged from the outlet opening of the cleaning lance is continuously moved back and forth in an oscillating manner in a direction perpendicular to the rotation axis of the turbine stage so that, after a period of time which can be established, the jet of the cleaning medium was guided at least once over all regions of each turbine blade of the turbine stage which are in principle intended to be reached by the jet. By appropriately selecting the rotation speed of the turbine stage and the oscillation speed, a uniform cleaning over the length of the individual turbine blades can also be ensured.

So that the device can be used in a variable manner for different engine models, the cleaning lance may be replaceable and/or the crank of the crank drive may be longitudinally adjustable. By means of replacement of the cleaning lance, the device can be adapted to different engine geometries. Via the longitudinal adjustment of the crank drive, the travel range of the device can be adapted to the length of the turbine blades which are intended to be cleaned.

Furthermore, other guide mechanisms are also possible, for example, guide mechanisms comprising a helical gear. The travel range of the device can then be freely controlled via the guide mechanism.

The guide mechanism can be driven manually, for example, by means of a hand crank. However, it is preferable for the guide mechanism to include a controllable drive, preferably a step motor, for moving the cleaning lance along the guide. If a crank drive is present, the drive can act on the crank drive; in the case of a helical gear, it can act on the threaded spindle.

For simpler handling, the device can preferably be disassembled into sub-assemblies. The device thereby does not have to be secured in a single step and as a whole to the jet engine, which, as a result of the required introduction of the cleaning lance into the opening of the jet engine, may be difficult, but it is instead possible to assemble the components which are combined to form sub-assemblies of the device one after the other. For example, the cleaning lance may form one sub-assembly, whilst the guide is associated with another sub-assembly. As a result of the ability of the device to be disassembled, the capacity of the device for storage and transport can also be improved.

The device according to the invention is preferably configured for cleaning with a cleaning medium comprising carbon dioxide. The carbon dioxide may be in the form of pellets, which are conveyed through the cleaning lance using a propellant gas. However, it is also possible to provide liquid carbon dioxide as a pre-stage of the cleaning medium. The liquid carbon dioxide at least partially solidifies when discharged from the cleaning lance and forms a solid component in the form of carbon dioxide flakes.

In order to improve the cleaning action with such a cleaning medium, there may be provision for the turbine blades to be heated prior to the cleaning with corresponding cleaning medium. The already good cleaning action of the cleaning medium is thereby further increased. This is because, as a result of previous heating of the turbine blade, the temperature difference between the cleaning medium and cleaning region is increased, which contributes to breaking up and flaking of contamination.

In order to heat the turbine blades, hot gas, in particular hot air, can be used. In this instance, the hot gas may be directed through the same cleaning lance to the turbine blades, through which the cleaning medium, for example, pressurized gas with carbon dioxide, is subsequently guided.

In order in this instance to prevent mixing of the cleaning medium with the hot gas, the device preferably has a switch valve for selectively supplying two media to the supply connection of the cleaning lance, wherein the switch valve is configured in such a manner that it switches from the second inlet of the switch valve discretely to the first inlet if there is sufficient pressure at the first inlet or a control inlet. The term “discrete switching” is intended to mean in this context that at no time during the switching from one inlet to the other inlet are both inlets even only partially open at the same time.

As a result of the switching device, the medium that is present at the second inlet of the switch valve, for example, hot gas, is prevented from coming into contact with the medium present at the first inlet. In the case of cleaning medium comprising solid carbon dioxide at the first inlet, an undesirable sublimation and clumping of the carbon dioxide can thus be prevented.

It is preferable for the switch valve to have a restoring element that switches the switch valve discretely from the first inlet to the second inlet if there is no longer sufficient pressure at the first inlet or a control inlet. As a result of a corresponding restoring element, the switch valve is switched to the second inlet if there is no longer sufficient pressure at the first inlet or the control inlet. If the switch valve is controlled directly via the first inlet, this is comparable with a lack of influx through this inlet. In any case, a return flow into the first inlet can be prevented by the switch valve.

Of course, the switch valve may also be used with any media other than the combination of cleaning medium comprising carbon dioxide and hot gas as mentioned merely by way of example.

The device according to the invention enables cleaning of turbine blades of a turbine stage, whilst the jet engine remains on the aircraft (on-wing). As a through-opening for the cleaning lance, it is possible to use, for example, a spark plug opening, a fuel injection nozzle opening and/or a borescope opening on the housing of the jet engine.

The invention is now described by way of example with reference to an advantageous embodiment and the drawings.

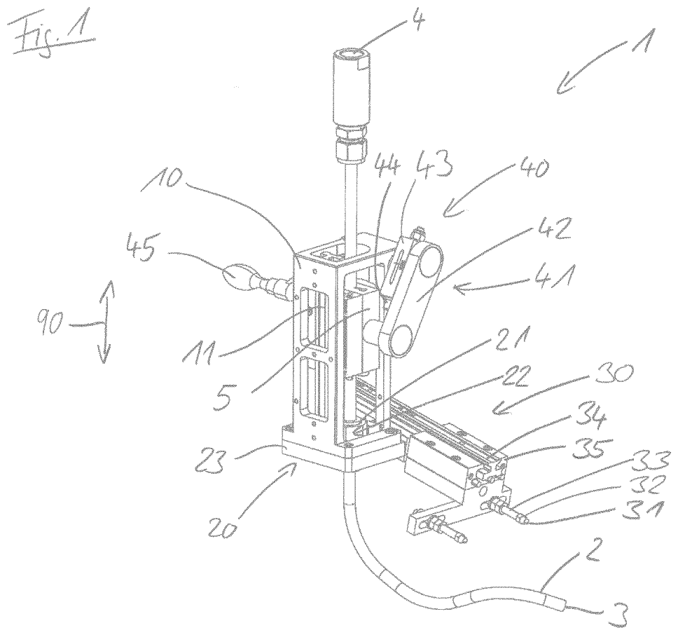

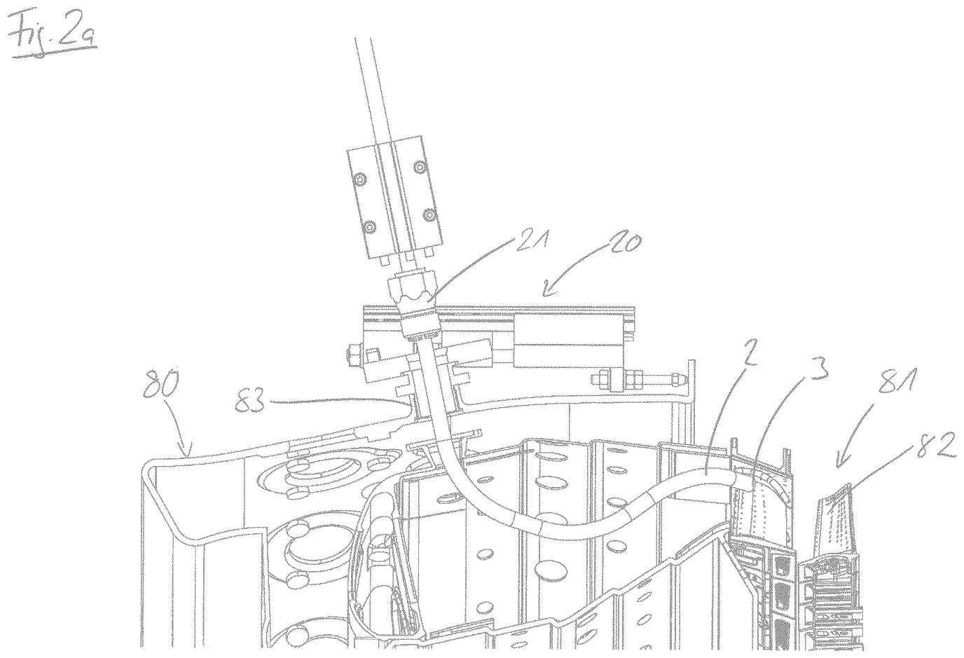

FIG. 1 shows a first embodiment of a device 1 according to the invention for cleaning turbine blades 82 of a turbine stage 81 of a jet engine 80.

The device 1 has a cleaning lance 2 which can be introduced through a lateral opening 83 into a jet engine 80. The cleaning lance 2 has at the end thereof which is intended to be introduced into the jet engine 80 an outlet opening 3 from which cleaning medium—for example, air with solid carbon dioxide—can be discharged under high pressure. The cleaning medium is supplied via a supply connection 4 to the other end of the cleaning lance 2.

The cleaning lance 2 is guided in a linear manner in a guide 10. To this end, the cleaning lance 2 is securely connected to a carrier 5, which is guided in a play-free manner on a linear guide 11 so that the cleaning lance 2 can be moved exclusively in the direction indicated by the arrow 90. The cleaning lance 2 therefore has—if guided in the guide 10—only a purely translational degree of freedom, whereby the cleaning lance 2 can be positioned in a clear and reproducible manner with respect to the guide 10—that is to say, by means of corresponding displacement along the guide 10.

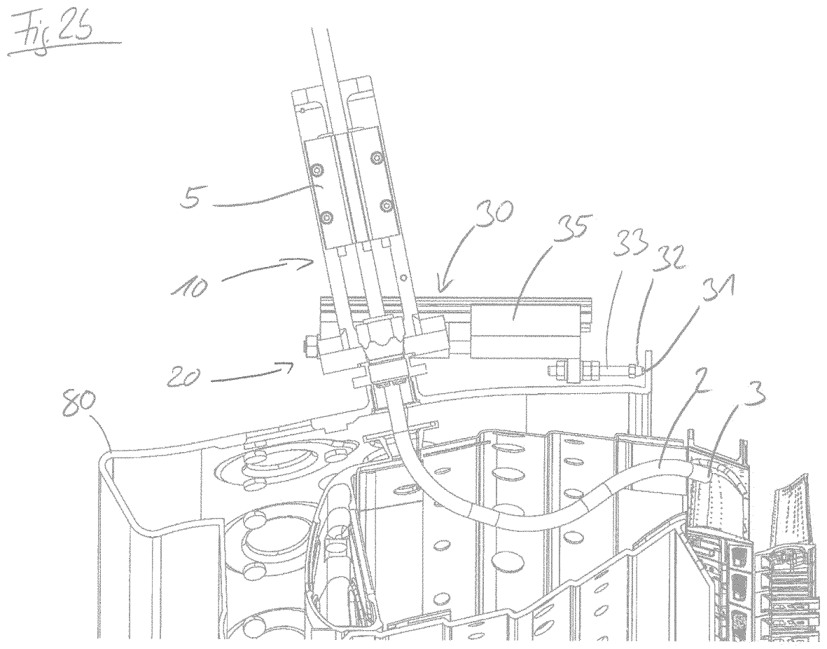

The device 1 further has a hollow screw 21 with a conically formed head 22, which together with a counter-piece 23 forms a securing device 20, via which the device 1 can be secured to the outer side of a jet engine 80. As will be further explained below with reference to FIGS. 2a-c, the conically formed head 22 of the hollow screw 21 allows a securing of the device 1 in the desired orientation of the guide 10 since between the hollow screw 21 acting as a portion of the securing device 20 and the counter-piece 23, a movable portion is provided as an additional portion of the securing device 20.

Furthermore, with the device 1, an orientation unit 30 is further provided as a portion of the securing device 20. The orientation unit 30 is securely connected to the counter-piece 23 of the securing device 20 and has a plurality of stop faces 31 in the form of the free ends 32 of adjustment screws 33. Furthermore, the adjustment screws 33 are further arranged on a carriage 35 which can be displaced along a linear guide 34, wherein the carriage 35 can be fixed in any position along the linear guide 34.

The device 1 also comprises a guide mechanism 40, by means of which the cleaning lance 2 can be moved along the guide 10, whereby the outlet end 3 of the cleaning lance 2 can ultimately also be linearly moved parallel with the direction 90.

The guide mechanism 40 includes a crank drive 41, the connecting rod 42 of which is pivotably secured at one end thereof to the carrier 5. At the other end thereof, the connection rod 42 is rotatably connected to a crank journal, which is arranged remotely from the crank axis on a crank 43, wherein the crank 43 is in turn rotatably supported about the crank axis. Via the adjustment screw 44, the spacing between the crank journal and crank axis can be changed, whereby the travel carried out by the carrier 5 can be adjusted in terms of its length.

In order to actuate the crank drive 41, a hand crank 45 is provided. However, it is also possible in place of the hand crank 45 to provide a controllable drive.

As can be seen below from the explanation of FIGS. 2a-c, the device 1 according to FIG. 1 can be disassembled into individual sub-assemblies, whereby the use of the device 1 is facilitated. A first sub-assembly includes the securing device 20 with an orientation unit 30, a second sub-assembly comprises the cleaning lance 2 including the carrier 5. The third sub-assembly comprises the guide 10, whilst the guide mechanism 40 forms the fourth sub-assembly.

FIGS. 2a-c schematically illustrate a typical use of the device 1 from FIG. 1.

Beginning with FIG. 2a, in a first step the first sub-assembly including the securing device 20 was initially placed on a lateral opening 83 of the jet engine 80 provided for introducing the cleaning lance 2—in this embodiment, a spark plug retention member, but not yet securely connected thereto. Subsequently, the cleaning lance 2 was guided as the second subassembly through the hollow screw 21 of the securing device 2 and subsequently through the opening 83 in the jet engine 80 so that the outlet opening 3 of the cleaning lance 2 is already in principle arranged in front of the turbine blades 82 to be cleaned, but without actually being orientated toward the inlet edges of the turbine blades 82.

Afterwards, the securing device 20 is orientated and the guide 10 is securely connected to the securing device 20 so that the orientation of the guide 10 is clearly defined by the orientation of the securing device 20. In FIG. 2b, the result of the steps which are described in greater detail below is illustrated.

Initially, the hollow screw 21 is screwed into the thread of the opening 82 in the jet engine 80, but not tightened so that, although the position of the securing device 20 with respect to the jet engine 80 and in particular the opening 83 is substantially fixed, the position of the securing device 20 can certainly still be changed.

Subsequently, the carriage 35 of the orientation unit 30 is displaced into a predetermined position and fixed at that location. In this position of the carriage 35, the stop faces 31 adjoin the free ends 32 of the screws 33 on a component of the jet engine 80—in this instance, a flange of the housing. This abutment ensures the correct orientation of the securing device 20, in which the securing device 20 is subsequently ultimately secured by tightening the hollow screw 21 on the jet engine 80.

Afterwards, the guide 10 is secured to the securing device 20, where the carrier 5 of the cleaning lance 2 is introduced into the linear guide 11. Because the securing device 20 is orientated via the orientation unit 30, the guiding unit 10, which is securely connected thereto, is also considered to be orientated because the guide unit 10 can be secured in only one predetermined position on the securing device 20.

Finally, the device 1 is completed as in FIG. 2c by the guide mechanism 40 being mounted on the guide 10. As a result of the guide mechanism 40, the carrier 5 can be moved in an oscillating movement linearly along the guide rail 11, whereby the outlet opening 3 of the cleaning lance 2 also makes a corresponding movement. As a result of suitable orientation of the cleaning lance 2 by means of corresponding orientation of the guide 10 or the securing device 20 and suitable adjustment of the stroke travel via the adjustment screw 44 of the crank drive, good cleaning of the turbine blade 82 can be ensured over the entire length thereof.

The device 1 according to FIGS. 1 and 2a-c is configured to clean with a cleaning medium comprising carbon dioxide, which forms dry ice flakes at the latest when the cleaning medium is discharged from the cleaning lance, wherein, before the passage of cleaning medium through the cleaning lance 2, hot air is blown into order to heat the turbine blades 83 which are intended to be cleaned.

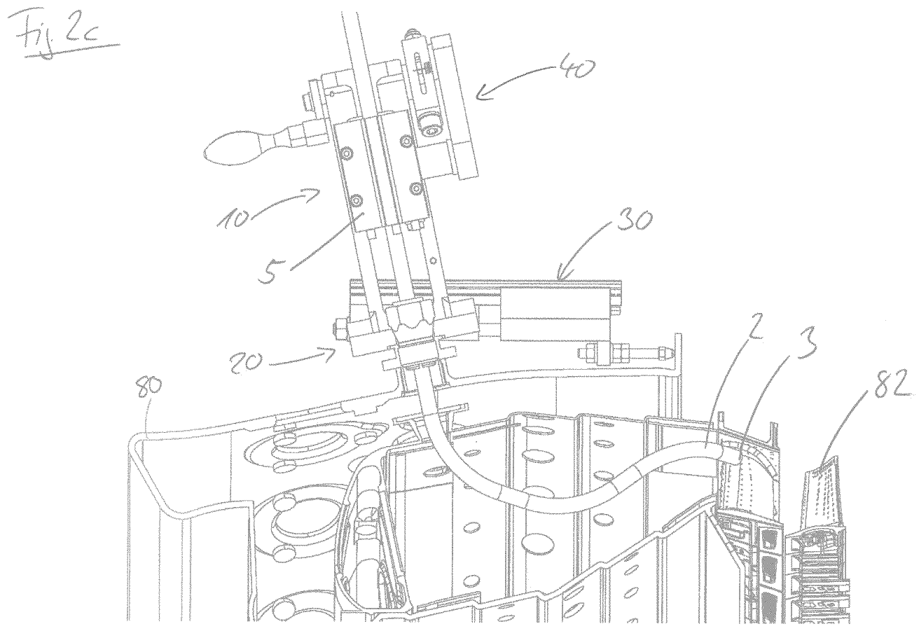

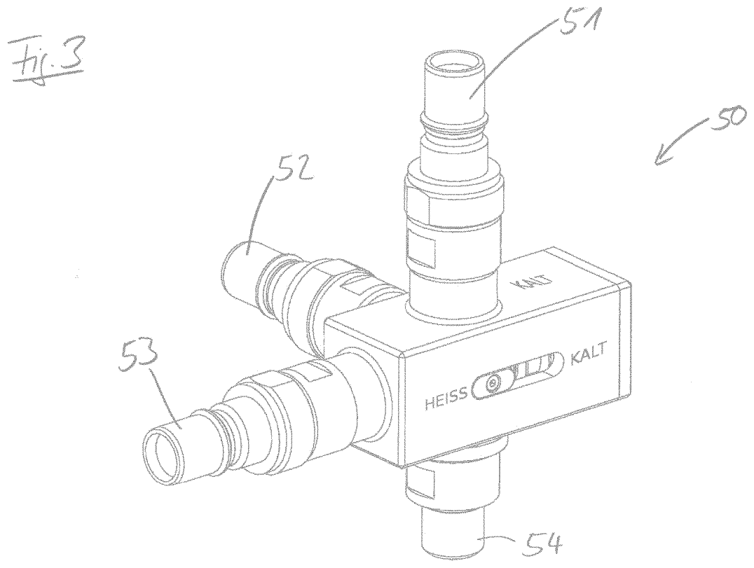

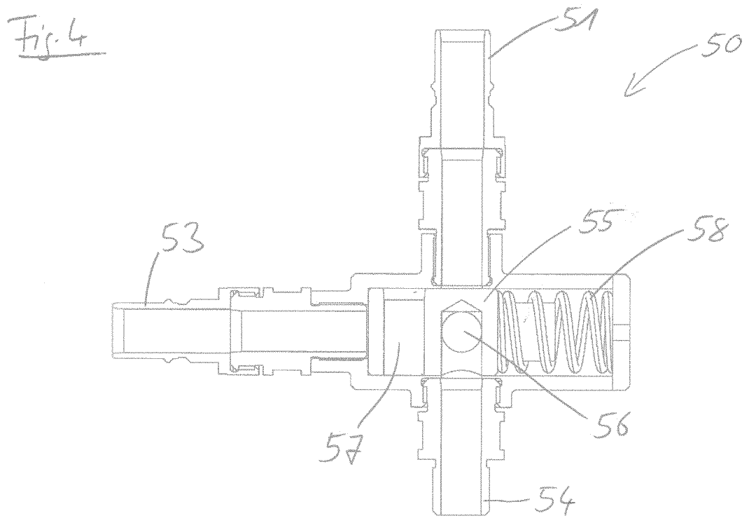

In order to prevent mixing of cleaning medium and hot air, a switch valve 50 according to FIGS. 3 and 4 is arranged upstream of the supply connection 4 of the cleaning lance 2 (cf. FIG. 1).

The switch valve 50 has a first inlet 51 for the cleaning medium, a second inlet 52 for the hot air, a control inlet 53 and an outlet 54. The outlet 54 is directly connected to the supply connection 4 of the cleaning lance 2.

The switch valve 50 is constructed for discrete switching between the first inlet and the second inlet 51, 52 as a result of a control pressure at the control inlet 53. In other words, the switch valve 50 is configured in such a manner that media which are supplied via the two inlets 51, 52 cannot at any time—not even during a switching operation—mix in the region of the switch valve 50, nor is there produced any return flow of a medium flowing in from one inlet into the other inlet.

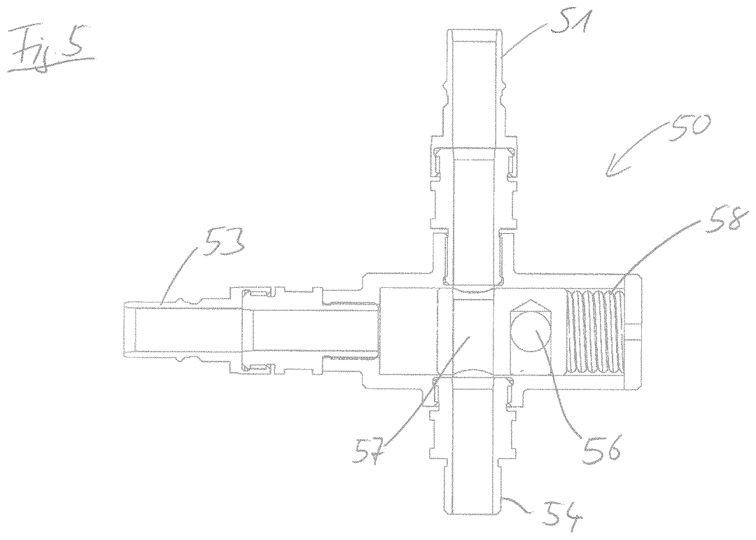

In the sectioned illustration according to FIG. 4, the inner side of the switch valve 50 is illustrated. The switch valve 50 includes a piston 55 having two line passages 56, 57. One line passage 56 is angled so that the hot air flowing through the inlet 52 in the direction from the blade level in the position of the valve illustrated in FIG. 4 is redirected toward the outlet 54. The other line passage 57 in the position shown in FIG. 5 connects the inlet 51 for the cleaning medium to the outlet 54.

The two line passages 56, 57 are configured in such a manner that in no position of the piston 55 between the two end positions shown in FIGS. 4 and 5 would both inlets 51, 52 be connected to the outlet 54 at the same time. Instead, there is an intermediate position of the piston 55, in which none of the two inlets 51, 52 is connected to the outlet.

The control of the switch valve 50 is carried out via the control line 53. If there is not sufficient pressure at the control inlet 53, the piston 55 is pressed by the spring 58 into the position which is illustrated in FIG. 4 and in which the second inlet 52 is connected to the outlet 54.

If the control inlet 53 is acted on with pressure which is sufficient to overcome the resilient force of the spring 58, the piston 55 is displaced into the position shown in FIG. 5, whereby the inlet 51 for the cleaning medium is connected to the outlet.

The control inlet 53 can be acted on by means of a bypass from the line which is connected to the inlet 51. In this instance, the switch valve 50 switches to the first inlet 51 as soon as there is sufficient pressure applied thereto to overcome the resilient force of the spring 58 via the bypass to the control inlet 53.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for cleaning turbine blades of a turbine stage of a jet engine, the device comprising:
a cleaning lance, which is configured to be introduced into the jet engine through a through-opening, the cleaning lance having an outlet opening at one end thereof and a supply connection for supplying cleaning media at an other end thereof;
a guide configured to guide the cleaning lance for clear and reproducible positioning and orientation of the cleaning lance; and
a securing device configured to releasably secure the guide to an outer side of the jet engine,
wherein the securing device is configured to adjustably orient the guide to a predetermined orientation with respect to the outer side of the jet engine.

2. The device as claimed in claim 1, wherein the guide is constructed to limit a movability of the cleaning lance to one degree of freedom.

3. The device as claimed in claim 1, wherein the securing device comprises a threaded portion for engagement in a thread of the through-opening for the cleaning lance.

4. The device as claimed in claim 1, wherein the securing device comprises one or more stop faces, which are configured to abut the jet engine.

5. The device as claimed in claim 1, wherein the device comprises a guide mechanism, which is configured to move the cleaning lance along the guide.

6. The device as claimed in claim 5, wherein the guide mechanism has a crank drive for moving the cleaning lance along the guide.

7. The device as claimed in claim 6, wherein the crank of the crank drive is longitudinally adjustable.

8. The device as claimed in claim 5, wherein the guide mechanism has a controllable drive for moving the cleaning lance along the guide.

9. The device as claimed in claim 1, wherein the device is configured to be disassembled into sub-assemblies.

10. The device as claimed in claim 1,
wherein the device has a switch valve for selectively supplying the cleaning media comprising two media to the supply connection of the cleaning lance, and
wherein the switch valve is configured in such a manner that it switches from a second inlet of the switch valve to a first inlet based upon there being a predetermined pressure at the first inlet or a control inlet.

11. The device according to claim 7, wherein the switch valve has a restoring element, which is configured to switch the switch valve from the first inlet to the second inlet based upon there not being the predetermined pressure at the first inlet or the control inlet.

12. The device according to claim 2, wherein the degree of freedom is configured in such a manner that, as a result of movement along the degree of freedom, the outlet end of the cleaning lance is moved in a direction radial relative to an axis of a rotor of the jet engine

13. The device according to claim 12, wherein the direction is linear.

14. The device according to claim 3, wherein the threaded portion is a portion of a hollow screw with a conically formed head.

15. The device according to claim 4, wherein at least a portion of the stop faces are adjustable.

16. The device according to claim 5, wherein the guide mechanism is configured to move the outlet end of the cleaning lance in a direction radial relative to an axis of a rotor of the jet engine.

17. The device as claimed in claim 8, wherein the controllable drive is a step motor.

18. The device according to claim 11, wherein the restoring element comprises a spring.
